(19) United States
(12) Patent Application Publication
(10) Pub. No.: US 2012/0007915 A1
(43) Pub. Date: Jan. 12, 2012

(54) Discharge Ink Collecting Apparatus

(75) Inventors: Hideo IZAWA, Narashino-shi (JP); Takao Namiki, Narashino-shi (JP); Wataru Itabashi, Narashino-shi (JP)

(73) Assignee: Miyakoshi Printing Machinery Co., Ltd., Narashino-shi (JP)

(21) Appl. No.: 13/178,099

(22) Filed: Jul. 7, 2011

(30) Foreign Application Priority Data
Jul. 7, 2010 (JP) JP 154436/2010

(51) Int. Cl. B41J 2/165

(52) U.S. Cl. 347/32

(57) ABSTRACT

It is sought to have a cap member sized to cover the entire lower surface of an ink jet head having numbers of nozzle heads, to improve intimacy of contact of the cap member with a carriage of the ink jet head, to obtain an enhanced airtightness between them and to enable the cap member to be manufactured roughly and at low cost.

An arrangement is disclosed comprising: a cap member shaped in the form of a pan such as to cover all the nozzle heads of the ink jet head, the cap member having a peripheral wall and an upper end portion of the peripheral wall which extends over its entire perimeter; a seal member having a base portion and an elastically deformable seal portion, the seal portion having a tongue-like cross section as being thinner at its tip portion than at its root portion, the base portion of the seal member being fastened to the upper end portion over the entire perimeter of the peripheral wall of the cap member while the elastically deformable seal portion being then tilted outwards of the peripheral wall of the cap member; and a lifting unit for lifting the cap member and the seal member fastened thereto up and down so that the tip of the said seal portion may be moved over between a position at which it is brought into contact with and elastically deformed against the lower surface of a carriage of the ink jet head at the ink discharge position and a position at which it is spaced from the lower surface of the said carriage.

### TECHNICAL FIELD

The present invention relates to a discharge ink collecting apparatus that is placed at an ink discharge recovery position of an ink jet head in an ink jet printer for receiving ink discharged from ink nozzles at a time of an ink discharge recovery operation of the ink jet head.

### BACKGROUND ART

Recovery of ink nozzles of an ink jet head from their clogging has been effected by one of two types of processing, namely of the pressure type in which ink is delivered under pressure to an ink nozzle so as to be discharged at idle (discharge not related to printing) and the suction type in which a negative pressure is applied to the front end of an ink nozzle so that ink may be drawn in from the ink nozzle. In either way, it has been the case that an end face of the ink jet head during such recovery processing is covered with a cap member to receive ink from ink nozzles of an ink jet head.

In the prior art, there has been known, for example, a discharge ink collecting apparatus for pressure recovery in which a head cap (i. e., cap member) is made in contact with the end face of an ink jet head via a rubber seal (see JP H03-81157 A). There has also been known an apparatus in which a plurality of ink jet heads are covered en bloc with a cap (i. e., cap member) (see JP H02-3324 A).

As such, however, in order that an ink jet head comprising numbers of nozzle heads arranged side by side in lines on a carriage may be covered with a cap member of a discharge ink collecting apparatus, the cap member must inevitably become larger in size. And, to prevent the ink jet head at its ink discharge recovery position from drying at its nozzle faces to prevent the nozzles from clogging, it is necessary that the end face of such a cap member be made in intimate contact, evenly with an entire end face of the carriage of the ink jet head. To this end, the end face of the cap member needs to be most improved in its smoothness at a cost. Thus, it has been thought difficult to make up the cap member roughly and at low cost, especially of a sheet metal, to meet with these demands.

And, as for one as in a conventional discharge ink collecting apparatus as first mentioned above in which a rubber seal may be interposed between an end face of its cap member and the ink jet head, much in elastic deformation is not to be expected of such a seal that is of rectangular cross section. Deficiency in smoothness of the end face of the cap member due to an error in its manufacture could not be thereby compensated for.

Made in view of the foregoing, the present invention has for its object to provide a discharge ink collecting apparatus comprising a cover member adapted to cover an entire ink jet head having a plurality of nozzle heads arranged on a carriage wherein the cap member even if its surface opposite to the ink jet head is large is excellent in its airtightness for the carriage of the ink jet head and the cap member can be formed roughly and at a reduced cost,

### DISCLOSURE OF THE INVENTION

In order to attain the object mentioned above, there is provided in accordance with the present invention a discharge ink collecting apparatus that is placed under an ink jet head at its ink discharge recovery position for receiving ink discharged from nozzle heads of the ink jet head by an ink discharge recovery operation, characterized in that the apparatus comprises: a cap member shaped in the form of a pan such as to cover all the nozzle heads of the ink jet head, the cap member having a peripheral wall and an upper end portion of the peripheral wall extending over its entire perimeter; a seal member having a base portion and an elastically deformable seal portion, the seal portion having a tongue-like cross section as being thinner at its tip than at its root, the base portion of the seal member being fastened to the upper end portion over the entire perimeter of the peripheral wall of the cap member while the elastically deformable seal portion being then tilted outwards of the peripheral wall of the cap member; and a lifting unit for lifting the cap member and the seal member fastened thereto up and down so that the tip of the seal portion may be moved over between a position at which it is brought into contact with and elastically deformed against the lower surface of a carriage of the ink jet head at the ink discharge position and a position at which it is spaced from the lower surface of the carriage.

And, in the discharge ink collecting apparatus of the makeup mentioned above, the base portion of the seal member is formed with a groove adapted to receive and to have the upper end portion of the peripheral wall of the cap member inserted enough so that its tip comes into contact with or against a bottom of the groove. Also, the cap member is one that is formed of a sheet metal.

According to the present invention whereby a cap member is adapted to cover an entire ink jet head comprising a plurality of nozzle heads arranged on the carriage, allowing its surface opposite to the ink jet head to be large, and a base portion of a seal member having a seal portion with a tongue-like cross section is fastened to an upper end portion of the cap member over its entire periphery, an excellent airtightness of the cap member for the carriage of the ink jet head in the state that the cap member is brought into contacting relationship with the carriage is attained with such a seal portion of the seal member, even if the upper end portion of the cap member whose surface opposite to the ink jet head may be large is poor or left poor in surface smoothness, and such a cap member can be made roughly and at low cost by sheet metal or thin plate working.

Also, the makeup of the seal member in which the groove in its base portion is adapted to be fitted with the peripheral wall of the cap member simplifies mounting the seal member to the cap member and further facilitates exchanging the seal member when damaged.

According to the present invention, covering the ink jet head as a whole with an excellent airtightness for the carriage of the ink jet head allows the entire ink jet head at its ink discharge recovery position to be prevented from drying as a whole.

### BRIEF DESCRIPTION OF THE DRAWINGS

In the Drawings:

FIG. 1 is a sectional view in part broken illustrating an essential part of a discharge ink collecting apparatus according to the present invention;

FIG. 2 is a perspective view illustrating a cap member in the discharge ink collecting apparatus; and

FIG. 3 is a cross sectional view illustrating a cross sectional shape of a seal member fastened to the cap member.

### BEST MODE FOR CARRYING OUT THE INVENTION

Mention is made of a form of implementation of the present invention with reference to the Drawing Figures.

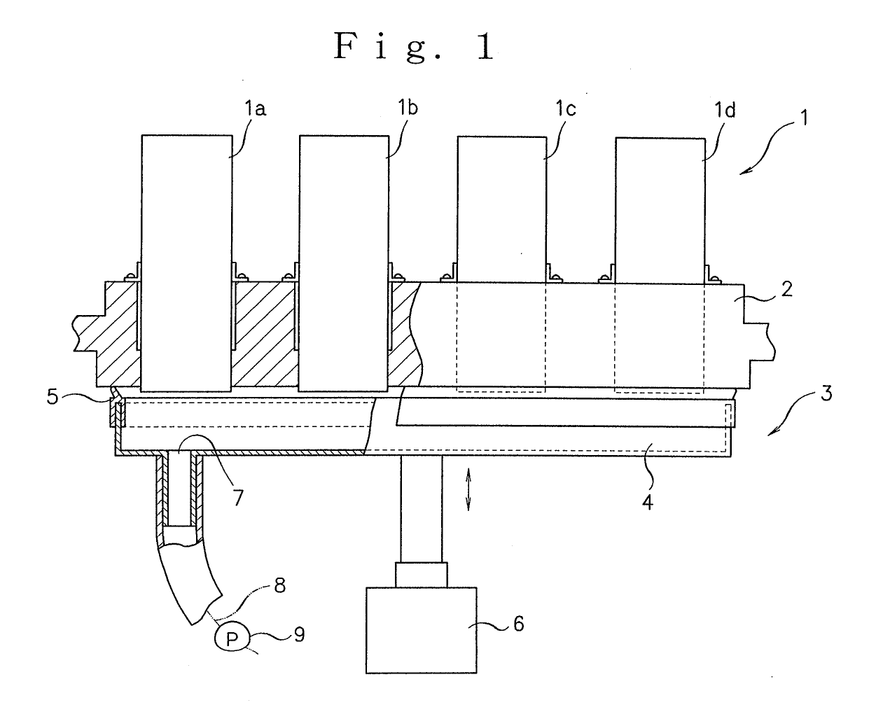

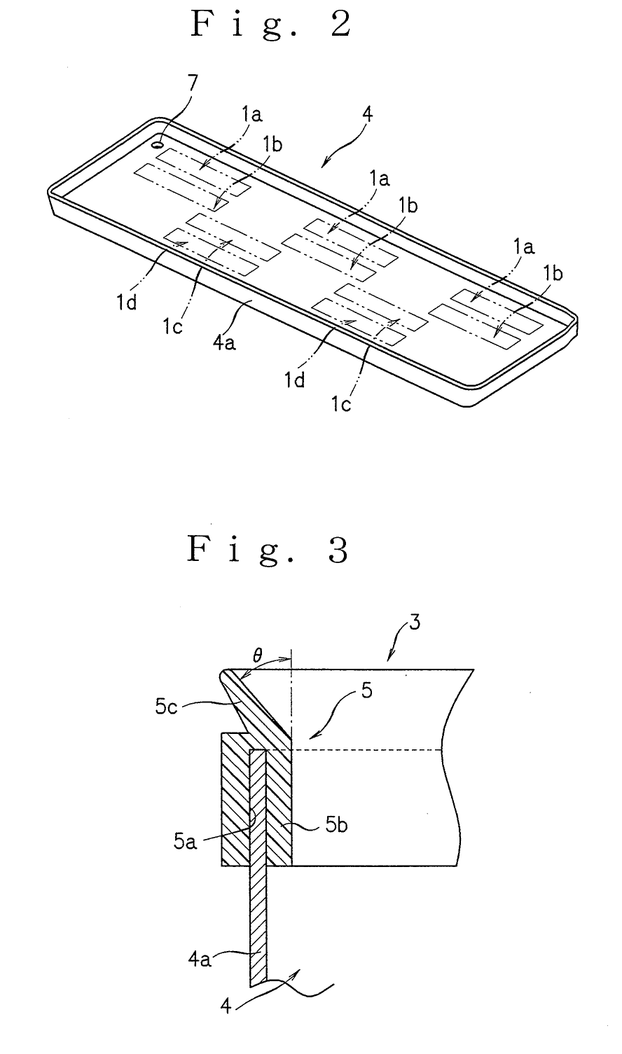

In an ink jet printer, an ink jet head 1 is shown comprising a plurality of nozzle heads 1a, 1b, 1c, 1d which are arranged side by side in a direction of travel of a printable sheet of paper and which are fastened to a carriage 2. The ink jet head 1 is designed to move reciprocating between a printing position at which it is opposite to the printing paper and an ink discharge recovery position out of the printing position as shown in FIG. 1. Each of nozzle heads 1a-1d comprises numbers of ink nozzles arranged in the form of a narrow paper tablet, and a plurality of such nozzle heads are arranged side by side in a direction orthogonal to the direction of travel of the printing paper, too. And, the carriage 2 has its lower surfaces constituting a horizontal plane around the individual nozzle heads 1a-1d.

In the ink jet printer in this form of implementation there have been used ink discharge recovery apparatus for ink jet heads, e. g., an apparatus of pressure recovery type in which pressure is allowed to act on each ink nozzle of the ink jet head at the ink discharge recovery position to let it discharge the ink at idle.

In the Figures there is shown a discharge ink collecting apparatus 3 which at the ink discharge recovery position is placed under the ink jet head 1 that has been moved to this position. The discharge ink collecting apparatus 3 comprises a cap member 4, a seal member 5 that is fitted a peripheral wall 4a of the cap member 4, and a lifting unit 6 for lifting the cap member 4 up and down at a prescribed stroke.

The cap member 4 is in the form of a pan having a given depth and its planar size is such that it encloses all the nozzle heads 1a-1d of the ink jet head 1. And, the cap member 4 is formed in its bottom plate with a drain hole 7 which is connected by a drain pipe with a drain passage 8. The drain passage 8 is provided with a suction pump 9 for drawing the ink from the drain hole 7.

The seal member 5 is made of an elastically deformable material such as urethane rubber and, with its sectional shape as shown in FIG. 3, consists of a base portion 5b formed with a groove 5a into which an upper end portion of the peripheral wall 4a of the cap member 4 is fitted over its entire perimeter and a seal portion 5c protruding from the upper edge of the base portion 5b. The seal portion 5c has a tongue-like cross section, being thinner in its tip and thicker in its root than in the tip. The seal portion 5c is tilted outwards of the peripheral wall 4a of the cap member 4 at a given angle of θ. Also, the upper end portion of the peripheral wall 4a of the cap member 4 is wholly inserted into the groove 5a of the seal member 5 so that its tip comes in contact with the bottom of the groove 5a. The tip edge of the seal portion 5c of the seal member 5 is designed to lie on a plane parallel to that on which the upper edge of the peripheral wall 4a of the cap member 4 lies.

The stroke of the lifting unit 6 by which the cap member 4 is lifted up and down is given so as to extend over from a position at which the tip part of the seal portion 5c of the seal member 5 is spaced from the lower surface of the carriage 2 of the ink jet head 1 lying at the ink discharge recovery position to a position at which the same comes into contact with the lower surface of the carriage 2 and is bent.

In the makeup mentioned above, the cap member 4 of the discharge ink collecting apparatus 3 placed at the ink discharge recovery position has been moved down at its rest, namely at the time of a printing operation by the ink jet head 1. When the ink jet head 1 is moved to the ink discharge recovery position to recover the ink discharge function of the ink nozzles in the ink jet head 1, the lifting unit 6 is operated to move the cap member 4 upwards. In this state, the seal portion 5c of the seal member 5 attached to the upper end portion of the cap member 4 comes into pressure contact with the lower surface of the carriage 2 of the ink jet head 1 and then, while being deformed flexurally outwards of the cap member 4, is brought into intimate contact with the lower surface of the carriage 2 of the ink jet head 1. The lower surface of the ink jet head 1 is then sealed up by the cap member 4 and the seal member 5.

The ink discharge recovery operation for the ink jet head 1 at the ink discharge recovery position may be performed by applying pressure to a discharge passage in each nozzle head so as to discharge the ink in idle. Then, since the lower surface of the carriage 2 of the ink jet head 1 is sealed up by the seal portion 5c of the seal member 5, there is no time the ink may leak from around the cap member 4. And, the ink discharged from the ink jet head 1 is stored in the cap member 4 and then is drained from the drain hole 7 and through the drain passage 8.

Also, when the ink jet head 1 is at rest from printing operation, the ink jet head 1 is moved to the ink discharge recovery position and then the cap member 4 is moved up to press the seal portion 5c of the seal member 5 against the lower surface of the carriage 2 of the ink jet head 1. Holding the state, each nozzle head of the ink jet head 1 at the printing rest time can be prevented from drying of its ink discharge surface.

While in the form of implementation above a recovery mechanism of pressure type has been illustrated as used for means for recovering ink discharge of the ink jet head 1, it should be noted that use may be made of one that is of suction recovery type which recovers ink discharge by suctioning ink from the cap member 4 with respect to the ink jet head 1. In this case, the force of suction may be created by the suction pump 9 provided in the drain passage 8.

In this case, too, it has been found that sealing up between the cap member 4 and ink jet head 1 by the seal portion 5c of the seal member 5 allows ink to be drawn quite well.

What is claimed is:

1. A discharge ink collecting apparatus that is placed under an ink jet head at its ink discharge recovery position for receiving ink discharged from nozzle heads of the ink jet head by an ink discharge recovery operation, characterized in that the apparatus comprises:
a cap member shaped in the form of a pan such as to cover all the nozzle heads of the ink jet head, the cap member having a peripheral wall and an upper end portion of the peripheral wall which extends over its entire perimeter;
a seal member having a base portion and an elastically deformable seal portion, the seal portion having a tongue-like cross section as being thinner at its tip than at its root, the base portion of the seal member being fastened to the upper end portion over the entire perimeter of the peripheral wall of said cap member while the elastically deformable seal portion being then tilted outwards of the peripheral wall of the cap member; and
a lifting unit for lifting the cap member and the seal member fastened thereto up and down so that the tip of said seal portion may be moved over between a position at which it is brought into contact with and elastically deformed against the lower surface of a carriage of the ink jet head at the ink discharge position and a position at which it is spaced from the lower surface of said carriage.

2. A discharge ink collecting apparatus as set forth in claim 1, wherein the base portion of the seal member is formed with a groove adapted to receive and to have the upper end portion of the peripheral wall of the cap member inserted enough so that its tip comes into contact with or against a bottom of the groove.

3. A discharge ink collecting apparatus as set forth in claim 2, wherein the cap member is one that is formed of a sheet metal.

4. A discharge ink collecting apparatus as set forth in claim 1, wherein the cap member is one that is formed of a sheet metal.
